(19) United States
(12) Patent Application Publication
(10) Pub. No.: US 2007/0290498 A1
(43) Pub. Date: Dec. 20, 2007

(54) Paper fastener compressor

(76) Inventors: Keith G. Foreman, Hummelstown, PA (US); Craig R. Wallace, Hummelstown, PA (US)

Correspondence Address: LITMAN LAW OFFICES, LTD., P.O. BOX 15035, CRYSTAL CITY STATION, ARLINGTON, VA, 22215, US

(21) Appl. No.: 11/812,073

(22) Filed: Jun. 14, 2007

Related U.S. Application Data
(60) Provisional application No. 60/813,357, filed on Jun. 14, 2006.

(51) Int. Cl. B42D 1/00

(52) U.S. Cl. 281/21.1

(57) ABSTRACT

The paper fastener compressor assembly includes a compressor bar having two opposed passages therein for the insertion of the prongs of the compressor base therethrough. A movable cover is hinged to the compressor bar along a common edge, with the cover also sliding axially along the hinge line when closed. The assembly is installed by opening the cover and placing the compressor bar over the extended prongs of the base, and folding the prongs over atop the compressor bar. The cover is then closed over the folded prongs and slid into registry atop the compressor bar to secure the edge of the cover opposite its hinge edge to the compressor bar. A locking tab is provided along the hinge edge of the compressor bar. When the locking tab is crimped, axial movement of the cover is prevented, thus securing the assembly permanently and preventing alteration of the file.

### CROSS-REFERENCE TO RELATED APPLICATION

This application claims the benefit of U.S. Provisional Patent Application Ser. No. 60/813,357, filed Jun. 14, 2006.

### BACKGROUND OF THE INVENTION

1. Field of the Invention

The present invention relates generally to clips, fasteners, and similar devices for securing multiple sheets of paper or similar material together in a file. More specifically, the present invention is a paper fastener compressor having a permanently lockable slide to prevent the opening of the compressor assembly and subsequent removal of the compressor and any papers from the file.

2. Description of the Related Art

The basic concept of the paper file fastener compressor has been known for some time. Such devices essentially comprise a base having a pair of opposed bendable prongs, which pass through prepunched holes in the stack of papers. The compressor bar is placed atop the papers with the prongs extending through holes defined in the compressor bar, and the prongs are bent over to lie atop the compressor bar. A sliding retainer is placed over each of the prongs to prevent them from unfolding, thereby retaining the papers in the file.

A later variation on the above described paper fastener compressor assembly includes a modification of the compressor bar. The modified bar is a two-piece assembly, with a relatively stationary compressor bar and a cover pivotally secured to the compressor bar. The cover is initially slid toward one end of the compressor bar, and opened. The compressor bar is then installed over the extended prongs of the fastener base, the prongs are folded to lie atop the compressor bar, and the cover is hinged downwardly to capture the prongs between the compressor bar and cover. The cover is then slid to center upon the compressor bar, with the open edge of the cover, i.e., the edge opposite the hinge edge, being captured by a retainer on the compressor bar to hold the cover in place immediately atop the compressor bar, with the folded prongs captured therebetween.

The above-described paper file fastener compressor assembly is quite effective at securing a stack of papers together in a file, with the cover being more effective than the two relatively small prong retainer slides of the earlier developed compressor. However, neither of the two types of paper file compressors described above provide any means for permanently securing the slide(s) or cover over the folded prongs of the base to prevent the compressor assembly from being opened to allow subsequent alteration of the file.

Thus a paper fastener compressor solving the aforementioned problems is desired.

### SUMMARY OF THE INVENTION

The paper fastener compressor includes a compressor bar having two opposed holes or slots therein for the insertion of the corresponding prongs of a paper file fastener base therethrough. The compressor bar further includes a cover permanently attached thereto by rolled hinge edges common to the compressor bar and cover, with one rolled edge of the cover captured within the corresponding rolled edge of the compressor bar. Thus, the cover can slide longitudinally and hinge arcuately open relative to the compressor bar, but cannot be separated therefrom.

The compressor bar further includes a first locking tab limiting the sliding action of the cover relative to the compressor bar, thereby retaining the cover on the compressor bar. The first locking tab is crimped into the hinge channel at the time of manufacture to prevent separation of the cover from the compressor bar. A second locking tab remains uncrimped at the time of manufacture in order to allow the cover to slide relative to the compressor bar. When the assembly is installed in a paper file, the prongs of the fastener base are inserted through the prepunched holes in the papers and through the holes or slots in the compressor bar of the compressor bar. The prongs are folded or bent to lie against the upper surface of the compressor bar, and the cover is pivoted downwardly and slid to lie in registry atop the compressor bar with the fastener prongs captured therebetween. The second locking tab may then be crimped into the hinge channel to prevent sliding of the cover relative to the compressor bar, thereby holding the cover closed and preventing removal of the compressor from the prongs of the fastener base.

The cover may include additional improvements, e.g., a grip portion having a central depression and a series of gripping ridges to each side of the central depression. The compressor bar and cover assembly may be formed of any suitable metal, but the assembly is preferably formed of aluminum and anodized for corrosion protection, and may be provided in different colors for color coordination with files, as desired.

These and other features of the present invention will become readily apparent upon further review of the following specification and drawings.

### BRIEF DESCRIPTION OF THE DRAWINGS

FIG. 1 is an exploded, environmental perspective view of a paper fastener compressor according to the present invention, showing its components and assembly relative to a paper fastener base.

FIG. 2 is a perspective view of the assembled paper fastener compressor of the present invention, showing the slide or cover locking tab crimped down to prevent opening.

FIG. 3 is a top plan view of the assembled paper fastener compressor of the present invention, showing the cover in an open position and the cover locking tab uncrimped.

FIG. 4 is a top plan view of the assembled paper fastener compressor of the present invention, showing the cover in a closed position but with the cover locking tab uncrimped.

FIG. 5A is a section view through lines 5A-5A of FIG. 4, showing details of the slide locking tab in its uncrimped configuration.

FIG. 5B is a section view through lines 5B-5B of FIG. 2, showing details of the slide locking tab in its crimped configuration.

FIG. 6 is an exploded perspective view of a paper fastener compressor according to the prior art.

Similar reference characters denote corresponding features consistently throughout the attached drawings.

### DETAILED DESCRIPTION OF THE PREFERRED EMBODIMENT

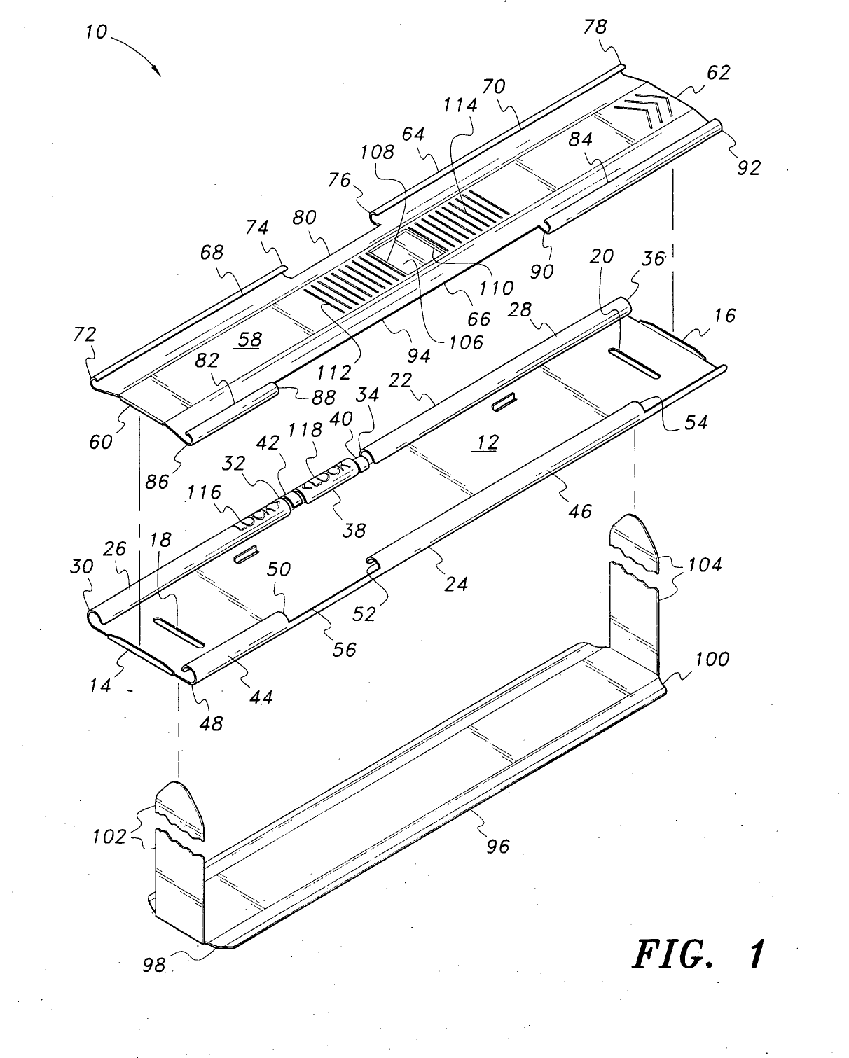

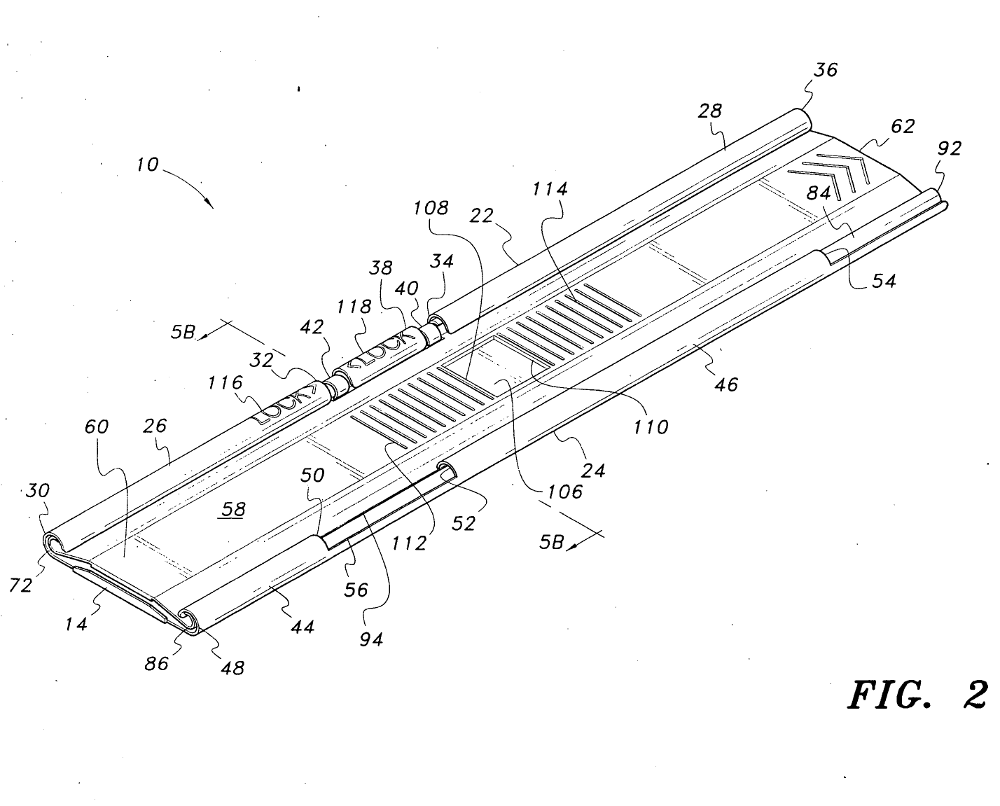

The present invention comprises a paper fastener compressor, which is used in cooperation with a fastener base for fastening paper files together, and which includes a tab which may be permanently crimped into position to prevent the subsequent opening of the compressor and alteration of the file. FIG. 1 of the drawings provides an exploded perspective view of the paper file fastener compressor, illustrating its general features, with FIG. 2 providing a perspective view of the assembled compressor with its components permanently locked in place relative to one another.

The paper fastener compressor 10 of FIGS. 1 and 2 includes an elongate compressor bar 12, preferably stamped from a piece of flat sheet metal stock and having its opposite edges bent and formed as described further below to provide the desired function. The compressor bar 12 includes mutually opposed first and second ends, respectively 14 and 16, with a passage, slot, or hole, respectively 18 and 20, provided adjacent each end for the installation of a base prong therethrough. The two base prong passages 18 and 20 may be of any practicable shape, e.g., round holes, etc., but are preferably formed as lateral slots extending across the compressor bar 12 between its opposite first and second edges, as shown in FIG. 1.

The first edge 22 of the compressor bar 12 is structured to serve as part of a hinge for the cover attached thereto, with the cover being described further below. The opposite second edge 24 serves as a retaining edge for the cover once the cover has been closed to lie immediately adjacent to the compressor bar 12. The first or hinge edge 22 of the compressor bar 12 defines a cylindrical hinge channel and includes a rolled first hinge element 26 and an opposite rolled second hinge element 28. The first hinge element 26 has a first end 30 abutting the first end 14 of the bar 12, and an opposite second end 32 at about one third of the length of the bar. The second hinge element 28 has a first end 34 at about the midpoint of the bar 12, and an opposite second end 36 abutting the second end 16 of the bar.

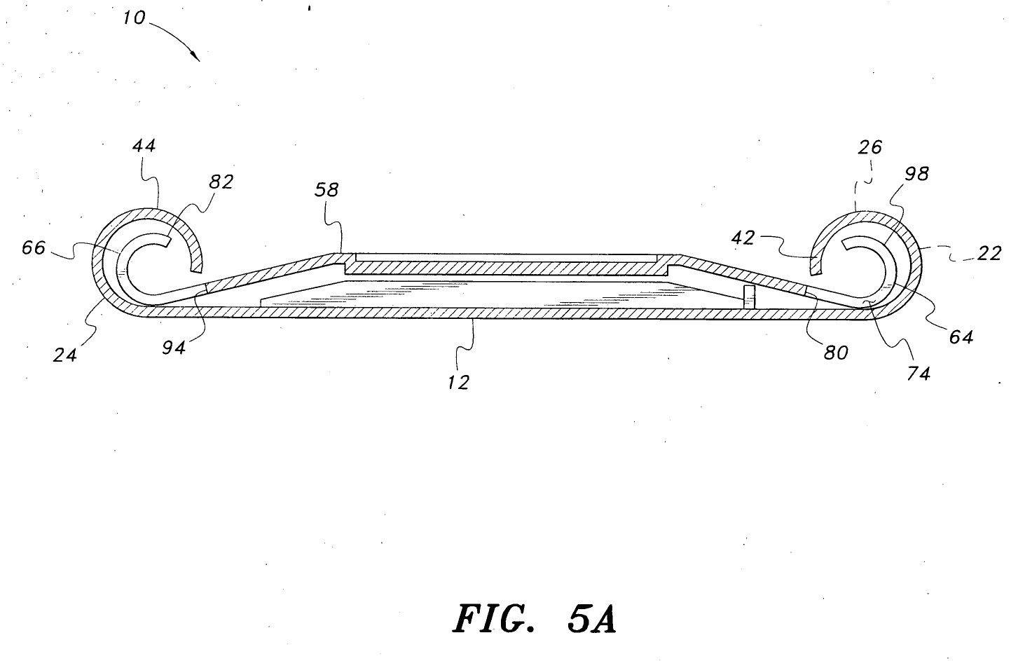

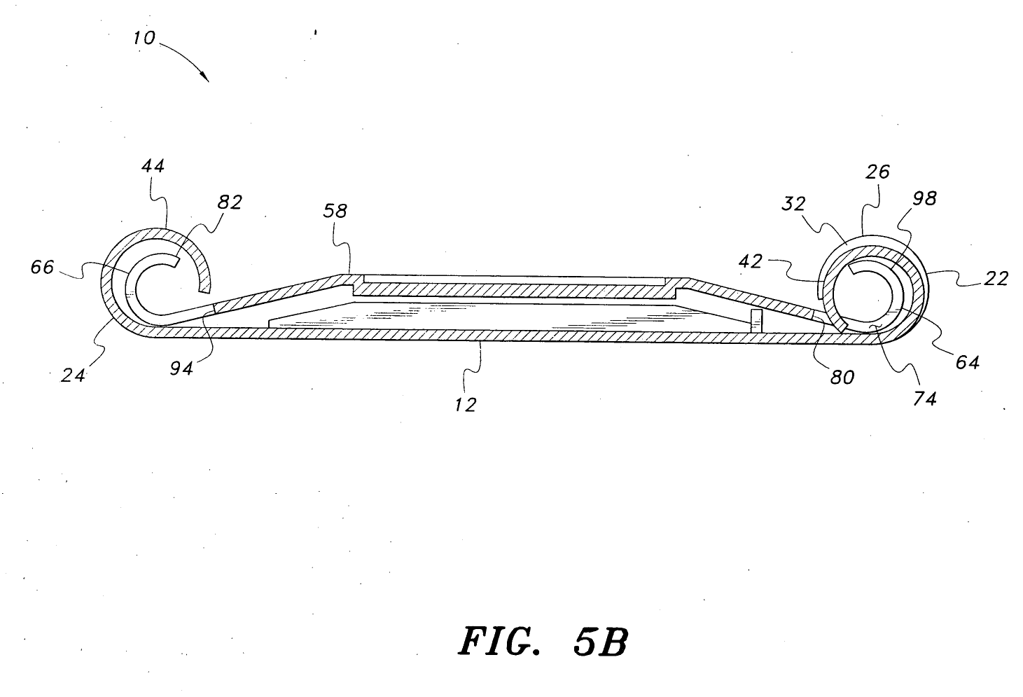

An intermediate rolled hinge element 38 is disposed between the first and second hinge elements 26 and 28, with a crimped cover retaining tab 40 disposed adjacent the first end 34 of the second rolled hinge element 28 between the intermediate hinge element 38 and the second hinge element 28. A locking tab 42 (shown in the unlocked or uncrimped configuration in FIGS. 1, 3, 4, and 5A, and in the locked or crimped position or configuration in FIGS. 2 and 5B) is disposed adjacent the second end 32 of the first hinge element 26 between the intermediate hinge element 38 and the first hinge element 26. The functions of these two crimped, or crimpable, tabs 40 and 42 are explained in detail further below.

The opposite second edge 24 of the compressor bar 12 defines a cylindrical latch channel and includes rolled first and second cover edge retaining flanges, respectively 44 and 46, formed thereon. The first cover edge retaining flange 44 has a first end 48 abutting the first end 14 of the bar 12, and an opposite second end 50. The second cover edge retaining flange 46 has a first end 52 at about one third the length of the bar 12 from the first end 14 thereof, and an opposite second end 54 spaced from the second end 16 of the bar. The two cover edge retaining flanges 44 and 46 define a cover edge clearance passage 56 therebetween, the function of which will be explained further below.

An elongate cover 58 is secured atop the compressor bar 12 by their mutual opposed edges. The cover 58 includes mutually opposed first and second ends, respectively 60 and 62, and mutually opposed first and second edges, respectively 64 and 66. The cover 58 further includes first and second rolled hinge pintles, respectively 68 and 70, disposed along the first edge 64. The first pintle 68 has a first end 72 abutting the first end 60 of the cover 58, and an opposite second end 74 at about one third the length of the cover from its first end. The second pintle 70 has a first end 76 located at about the midpoint of the cover 58, and an opposite second end 78 abutting the second end 62 of the cover 58. The second end 74 of the first pintle 68 and the first end 76 of the second pintle 70 define an axial cover movement slot 80 therebetween.

The two hinge pintles 68 and 70 are preferably rolled along the first edge 64 of the relatively thin sheet metal cover 58, with the external diameters of the two pintles 68 and 70 being no greater than the internal diameters of the two rolled hinge elements 26 and 28 of the compressor bar 12. The cover 58 is assembled to the compressor bar 12 by sliding the two cover pintles 68 and 70 into the corresponding hinge elements 26 and 28 of the compressor bar 12, with the first pintle 68 of the cover 58 sliding axially and rotating within the first hinge element 26 of the compressor bar 12 in order to be pivotally captured therein, and the second pintle 70 sliding axially and rotating within the second hinge element 28 in order to be pivotally captured therein.

Prior to assembly of the cover 58 to the compressor bar 12 at the time of manufacture, both the cover retaining tab 40 and the cover locking tab 42 are uncrimped, i.e., they have at least the same internal diameters as the two hinge elements 26 and 28 of the compressor bar 12. This allows the two hinge pintles 68 and 70 of the cover 58 to slide axially into the hinge elemerits 26 and 28 to pivotally secure the two components to one another. Once the cover 58 has been installed upon the compressor bar 12 during manufacture, the cover retaining tab 40 is crimped downwardly or inwardly to impinge upon the space of the axial cover movement slot 80 between the two hinge pintles 68 and 70 of the cover 58. Once the cover retaining tab 40 has been crimped, as shown in FIGS. 2 through 4, axial movement of the cover 58 relative to the compressor bar 12 is limited to the width or span of the axial cover movement slot 80, as either the second end 74 of the first pintle 68 or the first end 76 of the second pintle 70 contact the cover retaining tab 40 to limit the axial movement of the cover 58. Thus, the cover 58 can no longer be removed from the compressor bar 12 by sliding the two hinge pintles 68 and 70 from their corresponding hinge elements 26 and 28 of the compressor bar 12.

The opposite second edge 66 of the cover 58 includes first and second cover latch elements, respectively 82 and 84, disposed thereon. These two latch elements are preferably rolled in the manner of the first and second pintles 68 and 70 of the opposite first edge 64 of the cover 58, with external diameters no greater than the internal diameters of the corresponding first and second cover edge retaining flanges 44 and 46 of the second edge 24 of the compressor bar 12. This permits the two cover latch elements 82 and 84 to slide axially within the corresponding cover edge retaining flanges 44 and 46 of the compressor bar 12 to the limit defined by the crimped cover retaining tab 40 between the facing ends 74 and 76 of the two hinge pintles 68 and 70 of the cover 58.

The first latch element 82 includes a first end 86 abutting the first end 60 of the cover 58, and an opposite second end 88. The second end 88 is substantially conterminous with the second end 50 of the first cover edge retaining flange 44 when the cover is in complete registry with the underlying compressor bar 12. The second latch element 84 includes a first end 90 and an opposite second end 92. The second end 92 of the second latch element 84 abuts the second end 62 of the cover 58, while the first end 90 extends about one third of the distance from the second end 62 toward the opposite first end 60 of the cover 58. A compressor bar edge clearance slot 94 extends from the second end 88 of the first cover latch element 82 to the first end 90 of the second latch element 84 of the cover 58, with the clearance slot 94 allowing the cover 58 to be pivoted open relative to the compressor bar 12 prior to permanent securing of the two components, as described below.

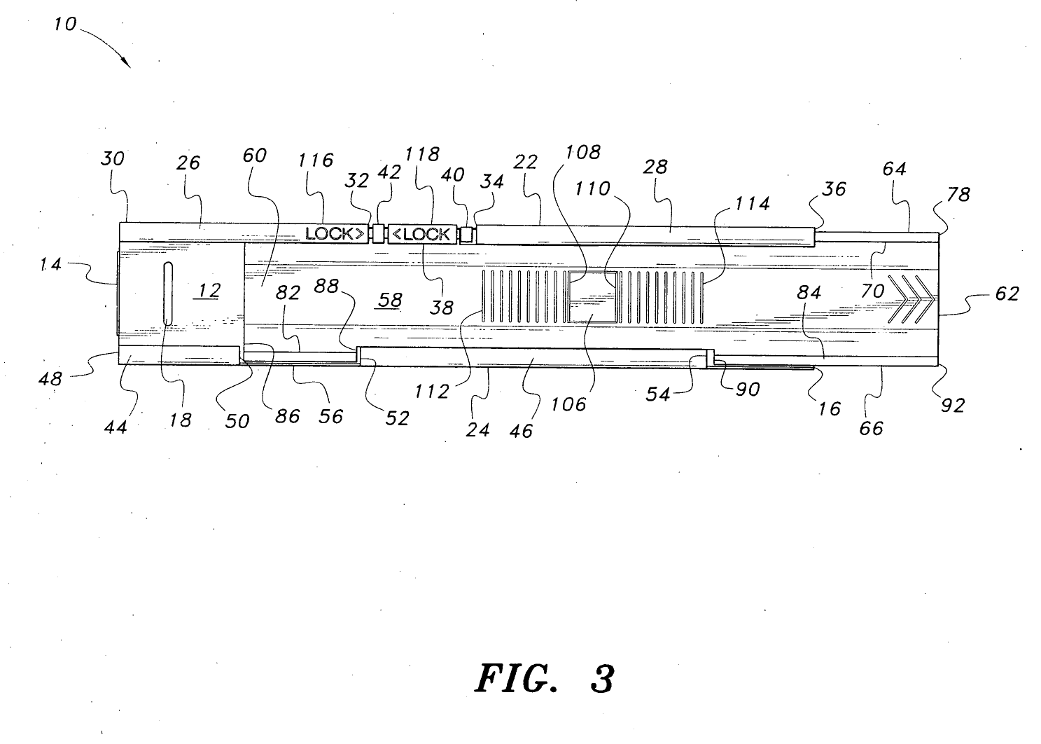

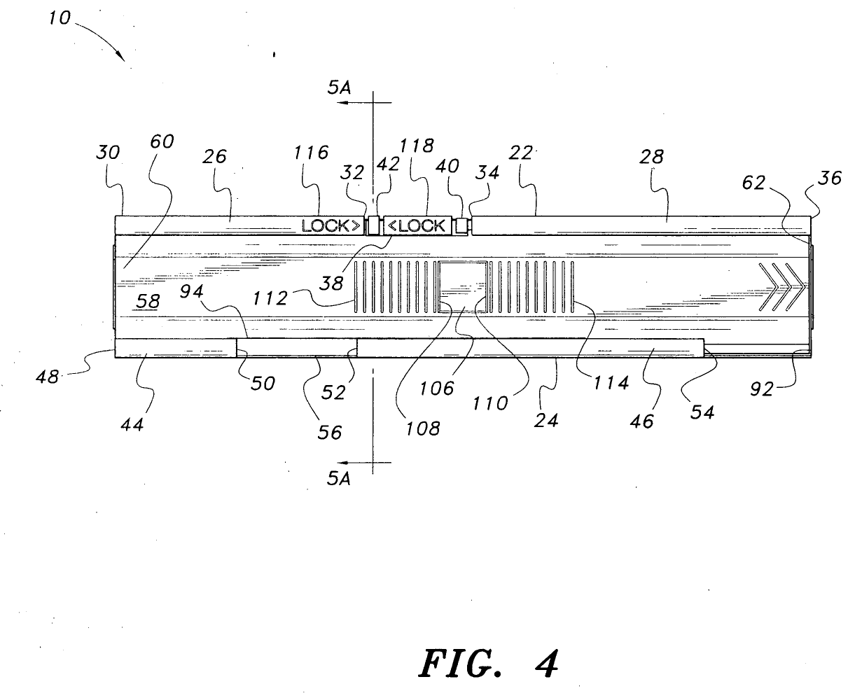

FIGS. 3 and 4 provide top plan views of the paper fastener compressor 10 with the cover 58 slid to an open position and with the cover slid to a closed position in registry with the underlying compressor bar 12, respectively. In FIG. 3, the cover 58 has been slid to its limit to the right, as the crimped cover retaining tab 40 engages the second end 74 (shown in FIG. 1) of the first pintle 68 of the cover 58 to prevent the cover from being moved farther to the right. However, it will be noted that the entirety of the length of the first cover latch element 82 of the cover 58 is aligned within the cover edge clearance passage 56 of the second edge 24 of the compressor bar 12, with the first end 90 of the second cover latch element 84 being clear of the second cover edge retaining flange 46 and its second end 54. This permits the cover 58 to be pivoted upwardly about its hinge line as defined by the two hinge pintles 68 and 70 of the cover 58 and their concentric installation within the corresponding hinge elements 26 and 28 of the compressor bar 12.

This permits the compressor bar 12 to be installed over the upright prongs of a conventional base component 96, generally as shown in FIG. 1 of the drawings. The base component 96 is formed of a thin sheet of metal and includes opposite first and second ends, respectively 98 and 100, with each end having a flexible or bendable prong, respectively 102 and 104, extending therefrom. The base component 96 is positioned beneath the stack of papers or file folder to be secured, with the two prongs 102 and 104 bent generally normal to the plane of the base 96, substantially as shown in FIG. 1. The prongs are inserted through holes in the file and/or papers, and the compressor bar 12 is placed atop the papers by placing the two slots or passages 18 and 20 of the compressor bar 12 over the prongs 102 and 104. The prongs are then folded toward one another to lie atop the compressor bar 12.

The prongs 102 and 104 are secured in place to prevent their unfolding by closing the cover 58 downwardly over the compressor bar 12 and aligning the first and second cover latch elements 82 and 84 of the cover 58 with the corresponding first and second cover edge retaining flanges 44 and 46 of the compressor bar 12, generally as shown in FIG. 3. The cover 58 is then slid to the left to the position shown in FIG. 4, with the cover latch elements 82 and 84 being captured and retained within the corresponding cover edge retaining flanges 44 and 46 of the compressor bar 12.

This configuration still permits the assembly to be reopened, if so desired, by reversing the movement of the cover 58 and sliding it back to its rightmost position as shown in FIG. 3. This clears the two latch elements 82 and 84 of the cover 58 from their engagement with the corresponding cover edge retaining flanges 44 and 46 of the compressor bar 12, thereby allowing the cover 58 to be pivoted open about its hinge pintle elements 68 and 70. This provides clearance for the prongs 102 and 104 to be unfolded or straightened, thereby allowing the compressor bar 12 (and its pivotally attached cover 58) to be removed from the file papers, if so desired. This operation may be repeated as desired, permitting the file of papers to be altered as much as desired.

However, in some cases it is not desirable that the paper file be altered in any way, but that it be retained as a permanent and unchanging record. The paper fastener compressor 10 permits the file to be locked permanently closed by bending or crimping the cover lock tab 42 downwardly into the axial cover movement slot 80 of the cover 58 when the cover and compressor bar 12 are in registry with one another, as shown in FIG. 4. The cover lock tab 42 is shown uncrimped in FIG. 4.

The cross-sectional views of FIGS. 5A and 5B illustrate the difference in the configuration between the uncrimped cover lock tab 42 (FIG. 5A) and the crimped cover lock tab (FIG. 5B). In FIG. 5A, the uncrimped tab 42 is aligned with the curvature of the rolled hinge elements 26, 28, and 38 of the compressor bar 12, with the first hinge element 26 being concealed behind the uncrimped tab 42 and indicated by the broken lead line in FIG. 5A. The alignment of the curvature of these elements 26 and 38 allows the first hinge pintle 68 of the cover 58 to slide axially to the limit set by the previously crimped cover retaining tab 40, thereby allowing the cover to be opened when slid to the right as shown in FIG. 3.

The downward or inward crimping of the cover lock tab 42 positions the tab 42 directly adjacent to and aligned with the second end 74 of the first hinge pintle 68 of the cover 12, generally as shown in the cross-sectional view of FIG. 5B of the drawings. The cover lock tab 42 may be crimped by means of a number of readily available and suitable tools such as a nail file, screwdriver blade, or even a fingernail or thumbnail applied to the thin, soft metal of which the device is made. When the cover lock tab 42 has been so bent or crimped, the lock tab 42 extends into the portion of the hinge channel defined in the gap between hinge elements 26 and 38, thereby blocking the slide path of the first hinge pintle 68 and preventing the cover 58 from sliding away from its in registry position with the compressor bar 12, as shown in FIG. 4, and into an open or openable position as shown in FIG. 3. Thus, the cover 58 is immovably and permanently affixed in registry with the compressor bar 12, thereby permanently securing the prongs 102 and 104 of the prong base 96 between the cover 58 and bar 12 and preventing any alteration of the file.

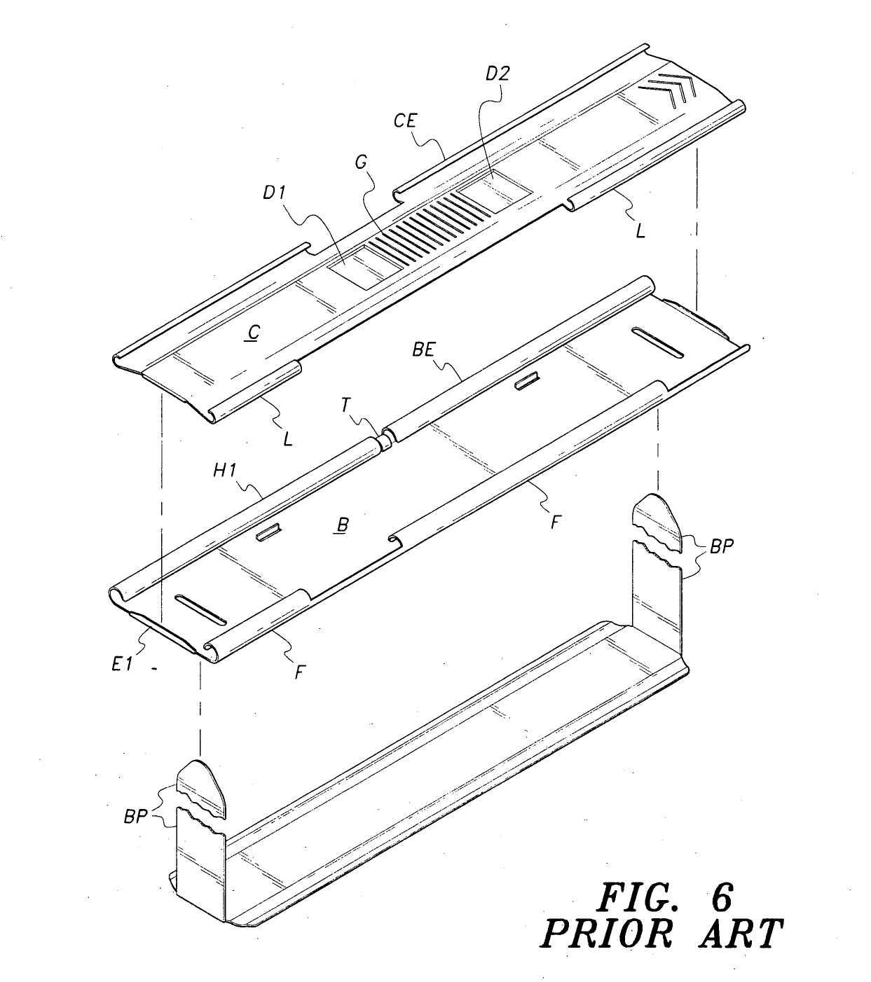

FIG. 6 of the drawings provides an exploded perspective view of a conventional paper fastener compressor of the prior art. The fastener assembly of FIG. 6 includes a compressor bar B, with a cover C pivotally attached thereto along their mutual bar and cover first edges BE and CE. The hinge pintle of the cover edge CE slides axially and pivots within the bar edge BE in the manner of the hinge components 26, 28, 68, and 70 of the paper fastener compressor 10 of FIGS. 1 through 5. The cover C is permanently retained upon the compressor bar B by crimping or folding the cover retaining tab T downward into the axial cover movement slot S of the cover C at the time of manufacture.

However, it will be noted that the first hinge element H1 of the compressor bar B extends continuously from the first end E1 of the bar to the cover retaining tab T. No cover lock tab is provided along the length of the hinge H1 in the conventional file fastener compressor assembly of FIG. 5. Thus, there is no way to permanently secure the cover C in registry with the underlying compressor bar B. This allows the cover C to be slid open as desired, to disengage the cover latch edge elements L from their respective retaining flanges F of the compressor bar B. Thus, a paper file secured with the conventional assembly of FIG. 5, may be reopened and altered at any time by anyone manipulating the assembly to access the base prongs BP of the underlying base component.

The paper fastener compressor 10 of FIGS. 1 through 5 may provide a single, central finger depression 106 in the cover 58, with the depression or indentation 106 having mutually opposed first and second ends, respectively 108 and 110, spaced apart by the width of the finger depression 106. A first and a second plurality of raised finger friction ridges or knurls, respectively 112 and 114, are positioned immediately adjacent the respective ends 108 and 110 of the central depression or indentation 106. This configuration permits the pad of the finger or thumb to be depressed into the central indentation 106, with the digit then forcefully engaging the raised finger friction ridges 112 or 114 to either side or end of the central depression, depending upon the direction in which the cover 58 is to be slid relative to the underlying compressor bar 12.

FIGS. 1 through 4 also show that a lock indicator may be provided to each side of the cover lock tab 42. A first lock indicator 116 (e.g., the word “LOCK,” or other suitable indicator) is marked on the first rolled hinge element 26 of the compressor bar 12 adjacent the second end 32 of the hinge element, with a second lock indicator 118 being marked on the intermediate hinge element 38. It will be seen that this positions the two lock indicators 116 and 118 to each side of the cover lock tab 42 with an arrow or other directional marking being provided with each lock indicator 116 and 118 to indicate the cover lock tab 42.

Paper fastener compressor assemblies are conventionally formed of a soft steel alloy having a very low yield strength, but with considerable ductility to allow innumerable bends to be made repeatedly in the material. This is particularly true of the base component and especially its prongs, e.g., the prongs BP of the prior art component of FIG. 5. A suitable metal alloy used for conventional file fastener compressors is 1010 steel. However, steel in any alloy form is relatively heavy in comparison to most other materials, e.g., aluminum, and the edges of the compressor bar B and cover C are uncoated and exposed to corrosion. It is envisioned that the paper fastener compressor 10 be manufactured of an aluminum alloy in order to save weight during shipping (more units per given amount of weight, therefore lower shipping costs per unit) and to resist corrosion.

The use of aluminum also allows the components to be anodized, which provides a more permanent coloring process for the device. Conventional paints do not hold up well in such an environment, due to the flexing of the base prongs which tends to crack and flake off any paint applied thereto. An aluminum alloy, such as 5056 alloy, provides similar low yield and high ductility to the conventional steel components used for conventional paper file fastener components, while saving considerable weight per unit and permitting a much more durable anodized color finish for the devices. The paper fastener compressor 10 may be provided in various colors in order to facilitate color coding paper in filing systems for quick identification of different types of files, e.g., different medical conditions in medical files, different financial situations, etc., as desired. Differently colored file fastener assemblies also permit the fasteners to be color coordinated with correspondingly colored files and/or papers.

In conclusion, the paper fastener compressor provides a much needed economical means of permanently locking and securing papers together in a file and preventing alteration of the file. The paper fastener compressor is little, if at all, more expensive to manufacture than conventional paper fastener compressors. Accordingly, the paper fastener compressor will prove to be a most desirable accessory in many, if not most, office and business environments.

It is to be understood that the present invention is not limited to the embodiment described above, but encompasses any and all embodiments within the scope of the following claims.

We claim:

1. A paper fastener compressor for attachment to the prongs of a fastener base, the compressor comprising:
an elongate compressor bar having holes defined therein adapted for passage of the prongs therethrough, the compressor bar having opposed longitudinally extending first and second rolled edges, the first rolled edge defining a hinge channel and the second rolled edge defining a latch channel;
a flat, elongate cover having opposed longitudinally extending first and second rolled edges, the first rolled edge forming a hinge pintle slidably and rotatably disposed in the hinge channel, the second rolled edge forming a latch slidable in the latch channel;
a cover retaining tab extending into the hinge channel, the hinge pintle having an elongate axial movement slot defined therein splitting the pintle into first and second hinge pintle portions disposed on opposite sides of the retaining tab, the pintle being axially slidable in the hinge channel for the length of the slot, the retaining tab blocking the pintle from sliding out of the hinge channel, the latch and the latch channel having corresponding gaps defined therein so that the cover is rotatable about the pintle to an open position normal to the compressor bar and rotatable to a closed position with the latch aligned with the latch channel, the cover being slidable to releasably dispose the latch beneath the second rolled edge of the compressor bar; and
a lock tab having an open position disposed above the hinge channel to permit slidable movement of the pintle in the hinge channel, the lock tab being bendable into the channel at the end of the slot opposite the cover retainer tab in a closed position blocking slidable movement of the pintle in the hinge channel.

2. The paper fastener compressor assembly according to claim 1, further comprising:
a finger indentation disposed generally centrally in said cover, the finger indentation having mutually opposed, spaced apart first and second ends;
a first plurality of raised finger friction ridges disposed adjacent the first end of said finger indentation; and
a second plurality of raised finger friction ridges disposed adjacent the second end of said finger indentation.

3. The paper fastener compressor assembly according to claim 1, wherein said compressor bar and said cover are both formed of anodized aluminum.

4. The paper fastener compressor assembly according to claim 1, further including:
an intermediate rolled hinge element disposed upon said first edge of said compressor bar between said first and said second rolled hinge element thereof;
a first lock indicator disposed upon said first rolled hinge element adjacent the second end thereof; and
a second lock indicator disposed upon said intermediate rolled hinge element.

5. The paper fastener compressor assembly according to claim 1, wherein each base prong passage of said compressor bar comprises a lateral slot.

6. The paper fastener compressor assembly according to claim 1, further including:
a base component having mutually opposed first and second ends; and
a prong extending from each of the ends of said base component, selectively engaging the base prong passages of said compressor bar when assembled therewith.

7. A paper fastener compressor assembly for attachment to the prongs of a base element, the compressor assembly comprising:
an elongate compressor bar having mutually opposed first and second ends and a base prong passage disposed therethrough adjacent each of the ends, and mutually opposed first and second edges;
an elongate cover having mutually opposed first and second ends and mutually opposed first and second edges, the first edge of the cover pivotally and slidably engaging the first edge of the compressor bar, and the second edge of the cover being selectively captured by the second edge of the compressor bar;
a finger indentation disposed centrally in the cover, the finger indentation having mutually opposed, spaced apart first and second ends;
a first plurality of raised finger friction ridges disposed adjacent the first end of the finger indentation; and
a second plurality of raised finger friction ridges disposed adjacent the second end of the finger indentation.

8. The paper fastener compressor assembly according to claim 7, further comprising:
a first rolled hinge element disposed along the first edge of said compressor bar and abutting the first end thereof, said first rolled hinge element having mutually opposed first and second ends;
a second rolled hinge element disposed along the first edge of said compressor bar and abutting the second end thereof, said second rolled hinge element having mutually opposed first and second ends;
a crimped cover retaining tab disposed adjacent the first end of said second rolled hinge element;
a selectively crimped cover axial movement locking tab disposed adjacent the second end of said first rolled hinge element;
a first cover edge retaining flange disposed along the second edge of said compressor bar and abutting the first end thereof, said first cover edge retaining flange having mutually opposed first and second ends;
a second cover edge retaining flange disposed along the second edge of said compressor bar and spaced from the second end thereof, said second cover edge retaining flange having mutually opposed first and second ends;
a cover edge clearance passage disposed between the second end of said first cover edge retaining flange and the first end of said second cover edge retaining flange;
a first rolled hinge pintle having mutually opposed first and second ends, disposed along the first edge of said cover and pivotally captured within the first rolled hinge element of said compressor bar; and
a second rolled hinge pintle having mutually opposed first and second ends, disposed along the first edge of said cover and pivotally captured within the second rolled hinge element of said compressor bar, said first and said second rolled hinge pintle defining an axial cover movement slot therebetween, said cover axial movement locking tab holding said cover in permanent registry with said compressor bar when said cover axial movement locking tab is crimped inwardly with said first and said second cover edge retaining flange securing the second edge of said cover to said compressor bar, holding said cover closely adjacent said compressor bar and capturing the prongs of the base element permanently therebetween.

9. The paper fastener compressor assembly according to claim 7, wherein said compressor bar and said cover are both formed of anodized aluminum.

10. The paper fastener compressor assembly according to claim 7, further including:
an intermediate rolled hinge element disposed upon said first edge of said compressor bar between said first and said second rolled hinge element thereof;
a first lock indicator disposed upon said first rolled hinge element adjacent the second end thereof; and
a second lock indicator disposed upon said intermediate rolled hinge element.

11. The paper fastener compressor assembly according to claim 7, wherein each base prong passage of said compressor bar comprises a lateral slot.

12. The paper fastener compressor assembly according to claim 7, further including:
a base component having mutually opposed first and second ends; and
a prong extending from each of the ends of said base component, selectively engaging the base prong passages of said compressor bar when assembled therewith.

13. A paper fastener compressor assembly for attachment to the prongs of a base element, the compressor assembly comprising:
an elongate, anodized aluminum compressor bar having mutually opposed first and second ends with a base prong passage disposed therethrough adjacent each of the ends, and mutually opposed first and second edges; and
an elongate, anodized aluminum cover having mutually opposed first and second ends and mutually opposed first and second edges, the first edge of the cover pivotally and slidably engaging the first edge of the compressor bar, and the second edge of the cover being selectively captured by the second edge of the compressor bar.

14. The paper fastener compressor assembly according to claim 13, further comprising:
a first rolled hinge element disposed along the first edge of said compressor bar and abutting the first end thereof, said first rolled hinge element having mutually opposed first and second ends;
a second rolled hinge element disposed along the first edge of said compressor bar and abutting the second end thereof, said second rolled hinge element having mutually opposed first and second ends;
a crimped cover retaining tab disposed adjacent the first end of said second rolled hinge element;
a selectively crimped cover axial movement locking tab disposed adjacent the second end of said first rolled hinge element;
a first cover edge retaining flange disposed along the second edge of said compressor bar and abutting the first end thereof, said first cover edge retaining flange having mutually opposed first and second ends;
a second cover edge retaining flange disposed along the second edge of said compressor bar and spaced from the second end thereof, said second cover edge retaining flange having mutually opposed first and second ends;
a cover edge clearance passage disposed between the second end of said first cover edge retaining flange and the first end of said second cover edge retaining flange;
a first rolled hinge pintle having mutually opposed first and second ends, disposed along the first edge of said cover and pivotally captured within the first rolled hinge element of said compressor bar; and
a second rolled hinge pintle having mutually opposed first and second ends, disposed along the first edge of said cover and pivotally captured within the second rolled hinge element of said compressor bar, said first and said second rolled hinge pintle defining an axial cover movement slot therebetween, said cover axial movement locking tab holding said cover in permanent registry with said compressor bar when said cover axial movement locking tab is crimped inwardly with said first and said second cover edge retaining flange securing the second edge of said cover to said compressor bar, holding said cover closely adjacent said compressor bar and capturing the prongs of the base element permanently therebetween.

15. The paper fastener compressor assembly according to claim 13, further comprising:
a finger indentation disposed generally centrally in said cover, the finger indentation having mutually opposed, spaced apart first and second ends;
a first plurality of raised finger friction ridges disposed adjacent the first end of said finger indentation; and
a second plurality of raised finger friction ridges disposed adjacent the second end of said finger indentation.

16. The paper fastener compressor assembly according to claim 13, further including:
an intermediate rolled hinge element disposed upon said first edge of said compressor bar between said first and said second rolled hinge element thereof;
a first lock indicator disposed upon said first rolled hinge element adjacent the second end thereof; and
a second lock indicator disposed upon said intermediate rolled hinge element.

17. The paper fastener compressor assembly according to claim 13, wherein each base prong passage of said compressor bar comprises a lateral slot.

18. The paper fastener compressor assembly according to claim 13, further including:
a base component having mutually opposed first and second ends; and
a prong extending from each of the ends of said base component, selectively engaging the base prong passages of said compressor bar when assembled therewith.
